(19) United States
(12) Patent Application Publication
(10) Pub. No.: US 2011/0193706 A1
(43) Pub. Date: Aug. 11, 2011

(54) Sensor collar system

(76) Inventor: Hurley Dickerson, Norristown, PA (US)

(21) Appl. No.: 12/931,205

(22) Filed: Jan. 25, 2011

Related U.S. Application Data
(60) Provisional application No. 61/336,709, filed on Jan. 25, 2010.

(51) Int. Cl. G08B 23/00

(52) U.S. Cl. 340/573.3

(57) ABSTRACT

The Sensor Collar System provides a pet tracking system comprising an electronic transponder which incorporates Global Positioning System (GPS) technology which monitors the specific whereabouts of a pet as soon as it leaves the house. Configured to mount onto any pet's collar, this device features an internally contained, high-tech computer chip. Encased in a durable plastic casing, this chip is equipped with a tiny antenna which sends signals to the designated GPS satellite. The Sensor Collar System also features a handheld receiver, equipped with a screen that utilizes LEDs (light emitting diodes) or in another embodiment, an LCD (Liquid Crystal Display) to graphically display a pet's whereabouts. This makes it possible to pinpoint the animal's location anywhere on earth. The receiver is powered using a standard alkaline battery source or a rechargeable battery source such as lithium, nickel-cadmium or nickel-metal hydride.

### CLAIM OF PRIORITY

This patent application claims priority under 35 USC 119 (e) (1) from U.S. Provisional Patent Application Ser. No. 61/336,709 filed Jan. 25, 2010, of common inventorship herewith entitled, “Sensor Collar System.”

### FIELD OF THE INVENTION

The present invention pertains to the field of pet door devices, and more specifically to the field of sensor actuated automatic pet door and locator devices.

### BACKGROUND OF THE INVENTION

The prior art has put forth several designs for sensor actuated automatic pet door and locator devices. Among these are:

U.S. Pat. No. 5,992,096 to Pul De La Cerda and Brian R. Smith describes a controllable animal access system connectable to the door of a building, which has an opening covered by a pivotally moveable door. The animal access system has a motion detector associated with a reader which detects an encoded pet tag worn by a selected animal and actuates locking and unlocking mechanisms in response to reading an accepted code. Various other controls are provided for operation of the apparatus.

U.S. Pat. No. 5,999,095 to Mark J. Earl, et al. describes an access control unit for an electrified door lock which also toggles the state of an associated alarm. The unit is arranged to unlock the door only temporarily, but the alarm state is not toggled except by user request. The system is arranged to prevent the anomalous situation of an unlocked door and an armed alarm. Another aspect is the use of standardized key-receiving nests in disparate types of access control devices. Some disparate devices employ identical key-receiving nests, while others use different forms of nests. Yet all mate with and respond to a single type of key.

U.S. Pat. No. 6,859,171 to Jennifer Durst, et al. describes a method and apparatus for an object locator system for requesting and obtaining information about the location of a mobile object, having attached thereon a lightweight object locator, operable in a region served by a two-way paging system and a global positioning satellite system. The object locator may be selectively activated to conserve power or enabled to respond only when beyond or within a boundary. Further, the object locator system may provide the location information in several forms including rectangular or polar coordinates referred to a base station or origin, position on a map display, etc. In alternate embodiments the two-way paging system may be substituted by a direct wireless link or a satellite relay communications link; the location information may be translated into human readable form either before or after transmission from the object locator; the location information may be presented at an output as selectable text; spoken message or graphic display including a map; the location information may have associated therewith other information such as time the location was determined, the status of the object locator, the condition of the batter, position of the object locator relative to a boundary or electronic fence of to indicate an alarm condition; or the location information may be accessed or delivered by dial-up or automatic means.

U.S. Pat. No. 6,966,147 to Henry E. Solowiej, et al. describes an automatic pet door system which is disclosed. The automatic pet door system has a rectangular frame mounted between studs of a wall defining a passage for entry and exit of a pet. A door slidably moves within the frame between a lower closed position for closing the passage and an upper open position for opening the passage. The door is lifted by a drive means having a motor pulling a cable attached to the door. The motor is energized by a control means in response to a signal received from a magnetic transmitter worn by a pet when the pet approaches the door. A locking means prevents movement of the door upwardly from the closed position unless the door is moved by way of the drive means.

None of these prior art references describe the present invention.

### SUMMARY OF THE INVENTION

It is an object of the present invention to provide a sensor actuated automatic pet door and location device.

### BRIEF DESCRIPTION OF THE DRAWINGS

FIG. 1 is an elevational angled perspective view of a portion of the device of the present invention.

FIG. 2 is a right elevational angled perspective view of a portion of the device of the present invention.

FIG. 3 shows a right elevational angled perspective view of the device of the present invention in its retracted configuration.

FIG. 4 shows a right elevational angled perspective view of the device of the present invention in its closing configuration.

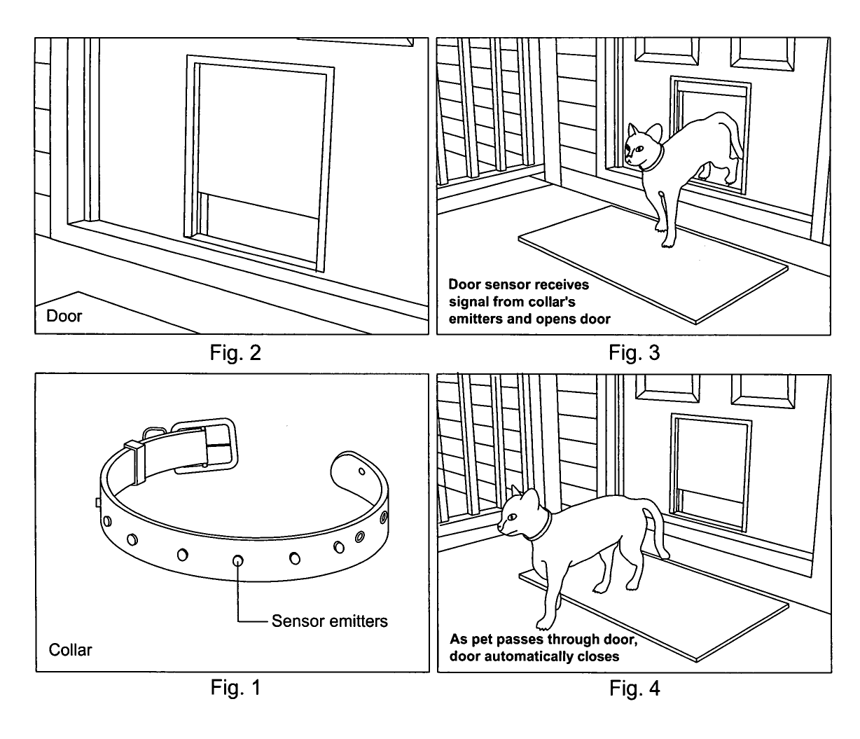

### DETAILED DESCRIPTION OF THE INVENTION

Pets are a major part of many families worldwide. In fact, recent estimates indicate that there are approximately more than 75 million pet cats and 60 million pet dogs throughout the United States. Offering their owners companionship, protection, and love, a strong emotional bond often develops between pets and their owners. Many equate the experience of owning a pet to that of having a young child, investing an abundance of time and energy into caring for them. As with raising children, pet ownership carries the responsibility of caring and providing for that pet. Pet owners not only strive to keep their animals well-fed and healthy, but also want to keep them safe from harm.

However, by nature pets roam. In Hollywood, movies about this subject typically have happy endings. Dogs and cats, after traveling half the country, come bounding out of a field of wildflowers into the arms of teary-eyed boys and girls. In reality, however, the facts are quite different. According to the National ASPCA, animal shelters take in approximately eight to twelve million lost pets a year. Only fourteen percent of dogs and four percent of cats have heartwarming reunions with their owners. Many of these reunions are a result of luck, an owner sees a flier of their lost pet posted by a caring individual that has taken the responsibility of surrogate care, a search effort finds a lost cat up in a tree, or after three days of being away from home the family dog miraculously appears at the front door. By contrast, one of the most heartbreaking experiences for pet owners is coming to terms once realizing that their pet has wandered from home and will not be found.

The present invention, hereinafter referred as The Sensor Collar System assists pet owners in locating a lost animal. The Sensor Collar System is a specially designed electronic transponder which incorporates Global Positioning System (GPS) technology which monitors the specific whereabouts of a pet as soon as it leaves the house. Configured to mount onto any pet's collar, this device features an internally contained, high-tech computer chip. Encased in a durable plastic casing, this chip is equipped with a tiny antenna which sends signals to the designated GPS satellite. The Sensor Collar System also features a handheld receiver, equipped with a screen that utilizes LEDs (light emitting diodes) or in another embodiment, an LCD (Liquid Crystal Display) to graphically display a pet's whereabouts. This makes it possible to pinpoint the animal's location anywhere on earth. The receiver is powered using a standard alkaline battery source or a rechargeable battery source such as lithium, nickel-cadmium or nickel-metal hydride.

The Global Positioning System consists of 24 earth-orbiting satellites. This technology allows any pet owner to know the precise location of a pet anywhere on the planet. GPS satellites send out radio signals to be detected by the computer chip inside the Sensor Collar System device. The antenna communicates with at least four satellites overhead, which is the minimum number needed for calculating position information such as altitude, latitude, and longitude. The receiver's display screen comes equipped with an electronic map stored in its memory. This device takes the coordinate information supplied by the GPS satellites and applies it to its internal, electronic map, graphically pointing out to the pet owner where their pet is located in relation to nearby roads, bodies of water, or other landmarks. As with standard GPS systems, the receiver not only places the pet on a map at a particular location, it also traces the pet's path across the map as it moves. The receiver also has the capability to show a “bread crumb trail,” or a visual rendering of the route the pet traveled from home.

There are several benefits and advantages associated with this unique product invention. Foremost, the Sensor Collar System allows pet owners to immediately locate the exact whereabouts of their pet in a situation where time is of the essence. Utilizing the technology of GPS, this easy to use device significantly increases the chances that the pet returns home safely. Moreover, the Sensor Collar System provides access to the exact route taken by a pet that wanders from home, effectively facilitating the location of the animal. Providing a focal point for the search, the digital display shows whether a dog or cat started its wanderings from the backyard or on the sidewalk in front of the house. In addition, this essential feature proves especially beneficial to pet owners on vacation, mapping out a specific direction when their pet gets lost in an unfamiliar area. As this compact and lightweight product is created to fit onto any collar, the Sensor Collar System is comfortable and virtually unnoticeable to the pet wearing it. Additionally, the durable weatherproof plastic casing ensures that the sensitive electronic components of the device is not shorted out or damaged. Eliminating the stress associated with losing a beloved pet, this handy product invention fosters confidence and peace of mind in pet owners that their dog or cat is safe from harm. Conceived primarily with pet owners in mind, this extremely versatile device also proves invaluable to veterinarians, breeders, the SPCA, and others involved in animal rescue. In addition, the technology inherent in this device is used to help find missing children.

The Sensor Collar System is an innovative and cleverly designed product invention which provides pet owners with a more practical means of protecting their cherished companion. Using today's technological advances, this unique device offers a superior means of finding and returning a pet home safely.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A sensor actuated automatic pet door and location device system, comprising:
an electronic transponder incorporating Global Positioning System (GPS) technology, wherein the device is mounted onto the collar worn by a pet, and comprises an internally contained computer chip, and wherein the device is encased in a durable plastic casing, and having a transponder with an antenna which sends signals to a designated GPS satellite; the system further comprising a handheld receiver, equipped with a screen that utilizes LEDs (light emitting diodes) to graphically display location of the transponder.

2. The system of claim 1 wherein the screen utilizes an LCD (Liquid Crystal Display).

3. The system of claim 1 wherein receiver is powered by an alkaline battery or a rechargeable battery including lithium, nickel-cadmium or nickel-metal hydride.

4. The system of claim wherein the receiver display screen comprises an electronic map stored in its memory.

5. The system of claim 1 wherein the receiver places the pet on a map at a particular location, and also traces the path traveled by the pet as it moves and a visual rendering of the route the traveled by the pet.
